(19) United States
(12) Patent Application Publication
(10) Pub. No.: US 2026/0235519 A1
(43) Pub. Date: Aug. 13, 2026

(54) PHOTOTHERMAL MICROSCOPY USING WHISPERING GALLERY MICROCAVITIES

(71) Applicant: Arizona Board of Regents on Behalf of the University of Arizona, Tucson, AZ (US)

(72) Inventors: Tsu-Te Judith SU, Tucson, AZ (US); Shuang HAO, Tucson, AZ (US)

(21) Appl. No.: 19/534,469

(22) Filed: Feb. 9, 2026

Related U.S. Application Data
(60) Provisional application No. 63/757,063, filed on Feb. 11, 2025.

(51) Int. Cl. G01N 21/64; G01N 21/01; G02B 26/10

(52) U.S. Cl. CPC G01N 21/6458; G01N 21/01; G01N 21/6402; G01N 21/648; G02B 26/105; G01N 2021/0106

(57) ABSTRACT

Photothermal microscopy systems and associated methods are disclosed that enable ultra-sensitive photothermal imaging, using whispering gallery mode (WGM) resonators, which for example can detect single 5 nm quantum dots with an SNR over 10⁴. One example photothermal microscopy system includes a WGM optical resonator, such as a microtoroid WGM resonator, which holds the particle of interest. The system also includes a modulated pump laser with a first wavelength having an amplitude modulation frequency that is less than 1000 Hz, and a probe laser with a second wavelength that is different from first wavelength for coupling to the resonator. The system also includes a photodetector that detects light from the resonator, a proportional-integral-derivative (PID) that receives signals from the photodetector. An output of the PID controller includes information indicative of shifts in resonance frequency of the optical resonator in response to illumination of the optical resonator with the amplitude modulated laser light.

### CROSS-REFERENCE TO RELATED APPLICATION(S)

This application claims priority to the provisional application with Ser. No. 63/757,063 titled “PHOTOTHERMAL MICROSCOPY USING WHISPERING GALLERY MICROCAVITIES,” filed Feb. 11, 2025. The entire contents of the above noted provisional application are incorporated by reference as part of the disclosure of this document.

### STATEMENT REGARDING FEDERALLY SPONSORED RESEARCH

This invention was made with government support under Grant No. GM137988 awarded by the National Institutes of Health (NIH). The government has certain rights in the invention.

### TECHNICAL FIELD

The field of currently claimed embodiments of this invention relates to photothermal microscopy systems and methods, and more particularly to photothermal microscopy systems and methods using whispering gallery mode optical resonators.

### BACKGROUND

The detection of individual particles and molecules can benefit many fields and applications; for example, it has had an impact in understanding protein dynamics, DNA and RNA analysis, cellular imaging, nanotechnology and nanomaterials, and biomedical diagnostics, among other fields. Traditional methods, such as single-molecule fluorescence-based detection methods are widely used, but they include several shortcomings, such as being restricted to a narrow range of molecular probes due to photoblinking, and photobleaching.

### SUMMARY

Photothermal microscopy systems and associated methods are disclosed that enable ultra-sensitive photothermal imaging in ambient air at room temperature, using whispering gallery mode (WGM) resonators, which for example can detect single 5 nm quantum dots (QDs) with an SNR over 10⁴. The measured heat dissipation of these 5 nm QDs is below the detectable level from single dye molecules, showcasing the high sensitivity and discrimination capabilities of the disclosed technology.

One example photothermal microscopy system includes an optical resonator configured to operate in a whispering gallery mode (WGM) and configured to accommodate a particle of interest, the optical resonator including a pillar below a top section of the microtoroid optical resonator, the pillar formed from a different material than the top section of the optical resonator. The photothermal microscopy system also includes a pump laser operable to produce a modulated pump laser light with a first wavelength for illuminating at least a portion of the optical resonator, wherein the pump laser light has an amplitude modulation frequency that is less than 1000 Hz, and a probe laser configured to provide probe laser light with a second wavelength for coupling into the optical resonator, the second wavelength being different than the first wavelength. The photothermal microscopy system additionally includes a photodetector positioned to receive light from the optical resonator and produce electrical signals or information corresponding to the light received thereon, and a proportional-integral-derivative (PID) controller communicatively coupled to the photodetector to receive the electrical signals or the information from the photodetector, the PID controller further communicatively coupled to the probe laser, wherein an output of the PID controller includes information indicative of shifts in resonance frequency of the optical resonator in response to illumination of the optical resonator with the amplitude modulated laser light.

### BRIEF DESCRIPTION OF THE DRAWINGS

FIG. 1A illustrates an example photothermal microscopy system in accordance with an example embodiment.

FIG. 1B illustrates an example plot of the resonance transmission spectra and its corresponding error signal based on measurements conducted using the system of FIG. 1A.

FIG. 1C illustrates an example plot of signal-to-noise ratio (SNR) versus amplitude modulation frequency of the pump laser based on measurements conducted using the system of FIG. 1A.

FIG. 2 illustrates a coarse and a fine photothermal map associated with detection of gold nanospheres in accordance with example embodiments.

FIG. 3 illustrates photothermal maps and detected intensity plots associated with detection of quantum dots in accordance with example embodiments.

FIG. 4 illustrates photothermal maps, histograms and detected voltage plots associated with detection of different quantum dots in accordance with example embodiments.

FIG. 5 illustrates photothermal images and SNR plots comparing PID and error signal methods obtained in accordance with some example embodiments.

FIG. 6 illustrates example plots of absorption cross section and heat dissipation of gold nanospheres with varying diameters as a function of wavelength obtained in accordance with some example embodiments.

FIG. 7 illustrates example simulation results showing resonance shifts for gold nanosphere at three different positions on the microtoroid in accordance with an example embodiment.

FIG. 8 illustrates photothermal mapping of a single quantum dot at different focus positions obtained in accordance with some example embodiments.

FIG. 9 illustrates photothermal images of single quantum does using stochastic optical reconstruction microscopy (STORM).

FIG. 10 illustrates a set of operations that can be carried out to detect a particle in a photothermal microscope system in accordance with an example embodiment.

### DETAILED DESCRIPTION

Traditional single-molecule fluorescence-based detection methods such as Stochastic Optical Reconstruction Microscopy (STORM) or Photo-activated localization microscopy (PALM) are powerful tools to study molecular processes. Such techniques are widely used and valued for their low background noise and high sensitivity. Fluorescence techniques, however, face limitations as they are restricted to a narrow range of molecular probes with high fluorescence quantum yields. Additionally, issues such as photoblinking and photobleaching limit their effectiveness.

As such, photothermal microscopy has emerged as a label-free non-invasive imaging technique. Photothermal microscopy measures localized variations in the refractive index of a sample's surroundings. These variations result from the absorption of light by sample components, which in turn induce temperature changes in the surrounding region. Photothermal microscopy can provide insight into the optical and thermal properties of materials and biological structures. Its high sensitivity renders it advantageous across a diverse array of applications, including material science, nanotechnology, biological imaging, and thermal metrology.

Currently, photothermal heterodyne imaging (PHI) is the predominant method for photothermal microscopy of single nano-objects. PHI can detect gold nanoparticles as small as 1.4 nm in diameter with a signal-to-noise ratio (SNR) over 10 and can measure the absorption spectra of single ~7 nm quantum dots (QDs) at room temperature with a SNR<10. By using multiple pump beams, PHI can perform multiplexed imaging, enabling simultaneous targeting and detection of gold and silver particles or dynamic imaging of mitochondria and lysosomes in living cells. Nanomechanical silicon nitride drums have also been used as mechanical transducers for photothermal imaging of single dye molecules, specifically Atto 633, with a heat dissipation of 6.3 pW. Although photothermal microscopy coupled with mechanical transducers exhibits high sensitivity, it is limited to operating under high-vacuum conditions. Furthermore, previously microtoroid optical resonators were combined with photothermal microscopy to detect 250 nm long gold nanorods and single polymers more than 100 nm in length. But this technique has been unable to detect small features including single particles and quantum dots, and suffers from a low SNR.

The embodiments described herein perform ultra-sensitive photothermal imaging in ambient air at room temperature, using whispering gallery mode (WGM) microtoroid resonators as detectors in photothermal microscopy, which for example can achieve single 5 nm QDs detection with an SNR over 10⁴ and with a simpler system and alignment requirement than PHI. WGM microtoroid optical resonators can measure small temperature changes induced from the heat dissipation of molecules. They are a class of optical microcavities known for their ultra-high quality (Q) factors, making them suited for a diverse set of applications, including single molecule detection, biochemical detection, and frequency comb generation. The Q-factor characterizes the efficiency and energy loss within the resonator and is mathematically expressed as Q=λ₀/Δλ, where λ₀ is the WGM resonant wavelength and Δλ is the full width at half maximum linewidth (FWHM) of the WGM. The ultra-high Q factor of WGM resonators results in a small mode volume, which in turn greatly enhances light-matter interaction. In addition, the narrow resonances of WGM enable precise measurement of the resonance shift. These high Q factors can enable photothermal microscopy with high sensitivity and precision.

Among various types of WGM optical resonators, such as microspheres, microdisks, microbubbles and microtoroids, microtoroids stand out due to Q-factors in excess of 10⁸, and a flat disk plate that facilitates the placement of nanoabsorbers. Previously, photothermal spectroscopy of single polymers greater than 100 nm in length with absorption cross-section of 6.7 nm² was demonstrated by measuring the resonance shift of microtoroids; however, detecting smaller particles has proven challenging due to the high background signal generated from the microtoroid's silicon pillar. To overcome this limitation, all-glass microtoroids have been designed and fabricated to minimize unwanted absorption from the supporting pillar. The all-glass fabrication process, however, leads to a sacrifice in the Q-factor, resulting in values around 10⁶.

Alternatively, we have opted for an easy fabrication method for microtoroids to both expand the effective detection area and preserve the high Q-factor. Here, we demonstrate photothermal microscopy based on several features that include a re-etched microtoroid and low amplitude modulation (AM) frequency of the pump laser. In some embodiments, we use the proportional-integral-derivative (PID) controller output signal to measure the resonance shift instead of the error signal as was previously used. The re-etching process of the microtoroid significantly decreases the size of the microtoroid pillar, providing two benefits: (1) it reduces the area with high background signal and (2) provides better thermal isolation of the microtoroid, enhancing the photothermal effect. In our approach, nanoparticles are deposited onto the top surface of the microtoroid. Upon illumination with a pump light at a wavelength of 405 nm, absorption of light by the nanoparticles leads to localized heating and dissipation within the resonator. In the case of the fused silica microtoroid, it possesses a positive thermal expansion coefficient (5.5×10⁻⁷ K⁻¹) and a positive thermo-optic coefficient (8.6×10⁻⁶ K⁻¹). Both positive coefficients contribute to the optical path length increasing, consequently leading to a redshift in resonance wavelength. The photothermal signal is directly related to the heat dissipation from the optical absorbing particles. The shift in the WGM resonance is proportional to the absorption cross-section of the nanoparticles. To detect these resonance shifts, we utilize an additional probe laser with a wavelength of 780 nm, which is intentionally detuned far away from the pump laser to avoid interference from nanoparticle or molecule absorption. Compared to the high frequency amplitude modulation of the pump laser used by others, we use low frequency modulation of the pump laser to enable the frequency lock-in system to track the oscillating resonance shift signal closely and accurately, improving the SNR of the photothermal signal.

In previous work, we developed a system called Frequency Locked Optical Whispering Evanescent Resonator (FLOWER), which combines optical microcavities with frequency locking and data processing to enable the detection of single macromolecules. Unlike conventional methods that involve scanning the wavelength of a tunable probe laser, which can be limited by scanning speed and hinder real-time tracking of resonance shifts, FLOWER uses a Pound-Drever-Hall (PDH) like technique to reduce the response time and enhance the accuracy of resonance shift measurement.

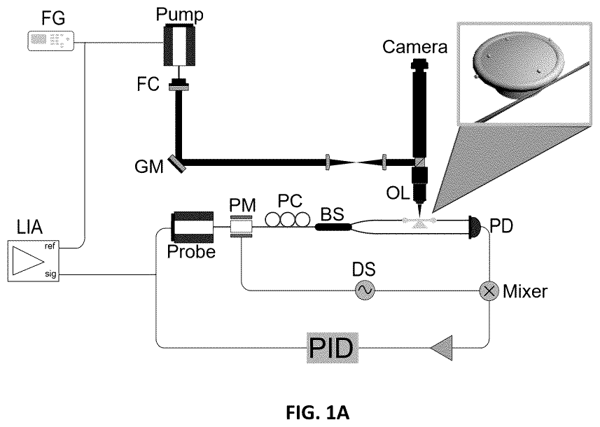

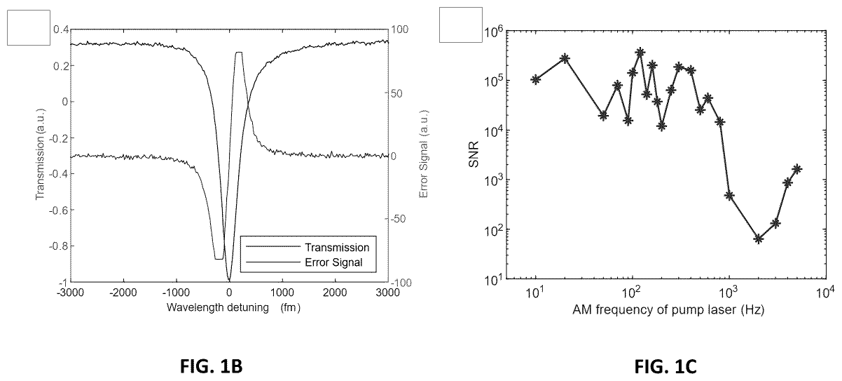

FIG. 1A illustrates our experimental setup that integrates FLOWER with photothermal microscopy. The example configuration shown in FIG. 1A provides for coupling a probe laser with a wavelength of 780 nm into the microtoroid resonator through a tapered optical fiber. The top right expanded image in FIG. 1A is a representation of the particle placed microtoroid coupling to tapered fiber. Key components illustrated in FIG. 1A include FG (Function Generator), FC (Fiber Collimator), GM (Galvo Mirror), LIA (Lock-in Amplifier), PM (Phase Modulator), PC (Polarization Controller), BS (fiber Beam Splitter), OL (Objective Lens), PD (Photodetector), DS (Dither Signal), PID (Proportional-Integral-Derivative controller), Probe laser and Pump laser.

In the example photothermal microscopy system (FIG. 1A), a continuous wave (CW) laser emitting at 405 nm serves as the pump laser. This specific wavelength resides at the boundary between visible and UV light spectra, aligning with the characteristic absorptions exhibited by a wide range of molecules and particles. This wavelength choice guarantees the generation of a robust photothermal signal. Significantly, the pump laser's wavelength is detuned from that of the probe laser, preventing any potential interference between the two.

Our system involves transmission of two beams of light into the microtoroid resonator. The first beam is the probe laser, which couples to the microtoroid via, for example, a tapered fiber. The second beam is the pump laser, propagating in free space which illuminates the microtoroid through a lens system. The pump laser output is directed through a fiber collimator (FC) to convert it into a free-space collimated beam. This collimated beam is then transmitted through a galvo mirror (GM) scan system and focused on the top surface of the microtoroid using a 60× objective lens. The relay lens, which comprises a scan lens and a tube lens, is positioned between the GM and the cubic beam splitter. The GM scan system allows for the variation of the incident angle, resulting in changes in the laser spot position on the microtoroid plane. By employing a two-axis rotation for the GM, a 2D spatial scan of the pump laser on the microtoroid can be achieved.

To optimize the coupling efficiency between the tapered fiber and microtoroid, in some embodiments, we control the polarization of the probe laser using a polarization controller (PC). A 25 MHz oscillation dither signal (DS) is applied to drive the phase modulator (PM), resulting in phase modulation of the probe laser. Subsequently, the phase-modulated probe laser is split into two arms through a fiber-coupled beam splitter (BS): one arm carries the signal light coupled into the microtoroid, while the other one serves as the reference light. Both the signal and reference light are then received by a high-bandwidth balanced photodetector (PD). In some embodiments, this balanced detector plays a crucial role in removing common noise from the probe laser. By multiplying the balanced photodiode's electrical output signal by the dither signal and time-averaging, we obtain an error signal that is proportional to the wavelength detuning between the probe laser and the WGM resonance of the microtoroid.

FIG. 1B shows an example plot of the resonance transmission spectra and its corresponding error signal, where the error signal becomes zero at the resonance peak wavelength when the probe laser perfectly matches the microcavity WGM resonance. The resonance transmission of the microtoroid resonance is acquired by the probe laser scanning. In this example, the Q factor of the resonance is 1.86×10⁶. Utilizing this error signal in a feedback loop with the tunable laser controller, the PID controller minimizes the error signal, thereby ensuring accurate and stable frequency locking of the probe laser to the WGM resonance.

Referring back to FIG. 1A, in some embodiments, the pump laser is amplitude modulated with a 203.7 Hz oscillating signal from a function generator (FG). The resulting 203.7 Hz AM signal in the resonance shift is detected by FLOWER. The amplitude of this oscillation directly correlates with the heat dissipation caused by the pump laser beam, effectively representing the photothermal signal. FIG. 1C depicts the SNR of the photothermal signal of single 5-6 nm QD as a function of the AM frequency for DiagNano (DN) 800 QDs (size:5~6 nm). The time constant was set as 1 s in lock-in amplifier. Remarkably, the SNR remains above 10⁴ when the AM frequency is below 200 Hz. To capitalize on the high SNR and achieve accurate real-time tracking of the photothermal signal, we utilize a lock-in amplifier (LIA) operating at the AM frequency of 203.7 Hz. Additional details regarding the AM frequency selection are provided in the Appendix. This combination of techniques significantly improves the SNR of the image acquired by the photothermal microscopy based on the re-etched microtoroid optical resonator.

In the PID control system disclosed herein, the output of the PID controller represents the resonance shift signal. Conversely, the error signal reflects the wavelength detuning between the probe laser and the WGM resonance. The oscillatory resonance shift with low frequency can be tracked more effectively by the PID controller output signal instead of the error signal. The PID method boasts an SNR exceeding tenfold that of the error signal method (see Appendix). During photothermal imaging experiments involving nanoparticles, we deposit QDs or Au nanospheres onto the microtoroid. However, the introduction of these nanoparticles induces additional losses, leading to a reduction in the Q-factor of the microtoroid.

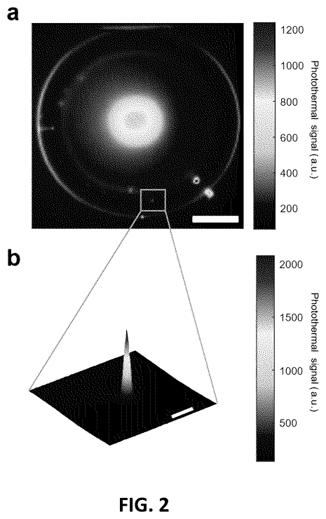

FIG. 2, panel (a), illustrates an example of a coarse photothermal map of the whole microtoroid. The diameter of Au nanosphere on the microtoroid is 100 nm at scale bar of 20 μm. Panel (b) in FIG. 2 is a zoomed-in section illustrating a fine photothermal map of single 100 nm Au nanospheres marked in panel (a) at scale bar of 2 μm. The Q-factor of the microtoroid with Au nanospheres is measured to be 1.86×10⁶. The selection of this specific Q-factor resonance is guided by careful consideration of its impact on the photothermal signal detection range. While higher Q factors generally lead to increased sensitivity, they may limit the effective tracking range of the resonance shift and risk destabilizing the frequency locking due to high photothermal signals. The Q-factor values achieved in the 10⁶ range are comparable to those observed in single-molecule detection using WGM resonators. Choosing a resonance with a Q factor in this range strikes a balance, enabling imaging of the entire microtoroid without saturation distortion while preserving good sensitivity. For detecting small single molecules with low absorption, selecting a resonance with a higher Q factor can further enhance sensitivity.

Example imaging of Au Nanospheres

The use of AU nanoparticles in conjunction with antibody labeling is a valuable technique for biomolecule detection. Au nanoparticles can serve as markers or tags that can be easily visualized and detected due to their distinct optical properties. Therefore, a 100 nm Au nanosphere was first selected as a target particle. The intensity of the 405 nm pump laser spot is 17.4 KW/cm², which is significantly below the melting point of the Au particles. A 2D scan of the microtoroid is first performed using the pump laser beam. The amplitude of the resonance shift is recorded with a double-locking mechanism, both from FLOWER and from the lock-in amplifier. The photothermal signal of each pixel during the 2D scan is the same and is longer than the time constant of the lock-in amplifier. The Au nanospheres are placed on the microtoroid using an aerosol generator. The 100 nm Au nanosphere physically bind on the microtoroid. As noted earlier, panel (a) in FIG. 2, presents the photothermal map of the entire microtoroid with Au nanospheres. The microtoroid structure consists of glass material for the disk and toroidal rim parts, which exhibit minimal absorption of the 405 nm pump laser. The supporting pillar of the microtoroid is made of silicon, which has high absorption. This configuration results in a low photothermal signal being generated by the microtoroid itself. In contrast, the pillar produces a strong and distinct photothermal signal. As a result, the effective detection area for particles is primarily the microtoroid area excluding the pillar. To expand the effective area for nanoparticle detection, secondary etching is employed during microtoroid fabrication, reducing the pillar size. Additionally, the smaller pillar contributes to the heat insulation of the microtoroid, thus improving the sensitivity of the photothermal signal. For example, as evident from panel (a) of FIG. 2, the diameter of the pillar (bright center spot) in this example configuration is about the same size as the 20-μm scale bar (white narrow rectangle at the bottom of panel (a)). In some embodiments, the diameter can be 10 microns or less. Panel (a) also shows multiple photothermal hotspots that are distributed around the rim of the microtoroid, representing the presence of 100 nm Au nanospheres. The absorption cross section of 100 nm Au nanosphere is calculated as σ_{Au}=1.9739×10⁴ nm². The heat dissipation is Pₕₑₐₜ=3.4277×10⁶ pW. The calculation details are provided in the Appendix. The fine photothermal map of an individual 100 nm Au nanosphere shown in panel (b) highlights the ease with which the 100 nm Au nanosphere can be detected using photothermal microscopy. To further explore the detection limits of this photothermal microscopy system, smaller nanoparticles were then chosen as target particles.

### Example Imaging of QDs

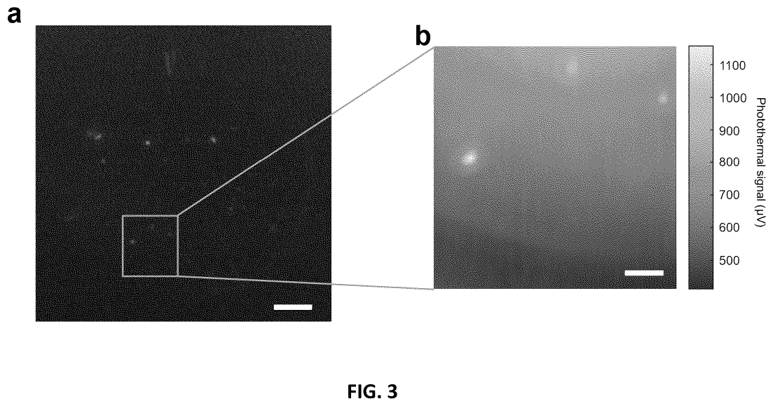

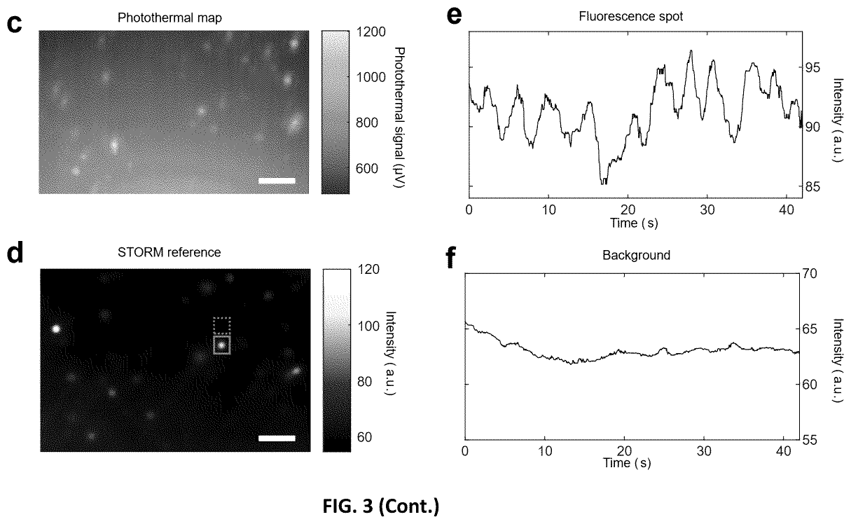

To demonstrate the high sensitivity of photothermal microscopy for single nanoparticles, we specifically opted for Qdot 800 QDs (Thermo Fisher Scientific) as our target particles based on their well-established and recognized characteristics. Firstly, the QDs emit stable fluorescence light at a peak wavelength of 793 nm. The fluorescence image can serve as a reference image for the photothermal map. Secondly, unlike fluorescence dyes, QDs do not undergo photobleaching, enabling longer observation times and stable fluorescence images. Thirdly, Qdot 800 QDs exhibit strong absorption in the UV spectrum, which matches the 405 nm wavelength of the pump laser. The diameter of the Qdot 800 QDs ranges from 18 nm to 20 nm. FIG. 3 in panel (a) displays the fluorescence image of Qdot 800 QDs on a microtoroid (scale bar of 10 μm), covering the entire WGM resonator and serving as a reference for subsequent photothermal imaging. Panel (b) shows photothermal image of three individual Qdot 800 QDs (scale bar 2 μm) that scanned using photothermal microscopy within the boxed region indicated in panel (a). The resulting photothermal image reveals three hot spots in the disk area of the microtoroid, corresponding to the three fluorescence spots observed in panel (a). To confirm that the photothermal signals originate from single QDs, a fine photothermal map of Qdot 800 QDs on another microtoroid is presented in panel (c) (scale bar 3 μm). Additionally, the same microtoroid is imaged using STORM, capturing the blinking behavior of the QDs. The superimposed frames of the STORM video form the fluorescence image shown in panel (d), where the same area as shown in panel (c) is illustrated. The characteristic single step blinking behavior of single QDs is evident in panel (e), illustrating the intensity profile of the spot within the square (boxed) region of panel (d). The background signal from the STORM fluorescence video captured from the dashed boxed region is depicted in panel (f).

Both the spot intensity and background signal are filtered by a median filter. The intensity of the single step blinking signal surpasses the background noise level, providing evidence for the presence of a single absorber and emitter. The sensitivity of the photothermal signal depends on the location of the absorber (see Appendix). The sensitivity near outer edge of the microtoroid is higher than in the location near the pillar. However, when selecting photothermal spots in the disk area while excluding the small pillar, the sensitivity does not significantly vary with changes in location. Photothermal microscopy enables precise identification of target locations on the microtoroid and accurate measurement of the absorption cross-section.

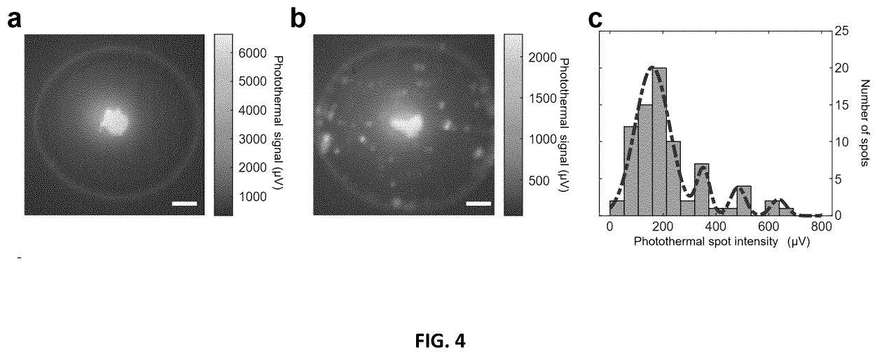

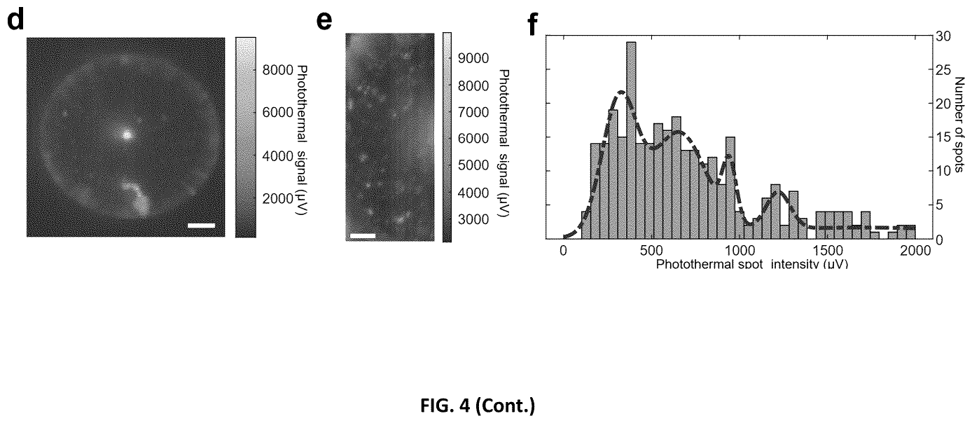

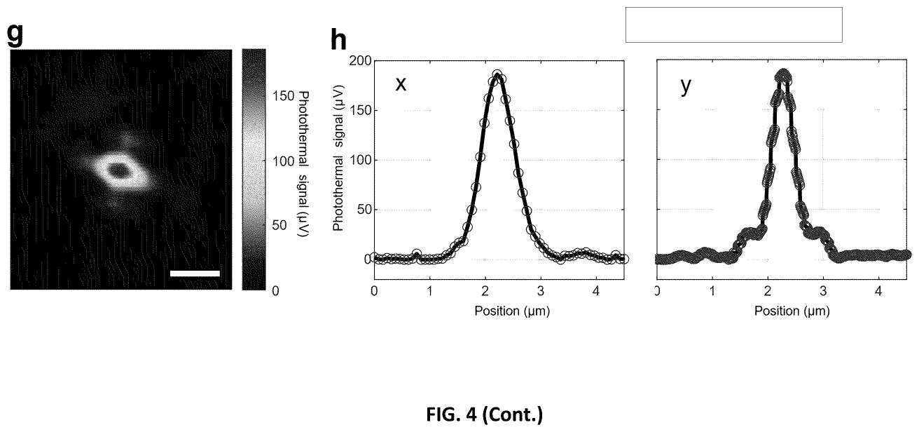

To explore the detection limits of photothermal microscopy, we employed a smaller QDs, DiagNano (DN) 800 (CD Bioparticles). One concern was the possibility of chemical contamination on the microtoroid during the coating process, which could contribute to undesired photothermal signals. To address this, we performed a control experiment by handling the microtoroid with the same coating process but without introducing any QDs. The resulting photothermal map of the control group (scale bar, 10 μm) is shown in panel (a) of FIG. 4, which exhibits no detectable photothermal spots. This finding provided evidence that either there was no contamination on the microtoroid during the chemical coating process or, if present, the remaining chemical material had minimal absorption at the 405 nm wavelength, thus contributing little to the photothermal signal. Next, we conducted photothermal imaging of DN 800 QDs on the microtoroid, (panel (b)). Although we attempted to observe the DN 800 QDs using fluorescence microscopy or STORM, their small absorption cross-section and lower quantum yield made it challenging to observe their fluorescence or photo blinking behavior of individual QDs. Here, we analyzed the fine photothermal map of the microtoroid (panel (b)) and constructed a histogram of the photothermal spot intensity as illustrated in panel (c). Notably, individual nanoparticles exhibit a monomodal distribution in the histogram of photothermal spot, while the presence of both aggregated QDs and single QDs on the microtoroid resulted in multiple peaks. Each peak followed a Gaussian distribution, representing distinct orders of QD aggregates. The peak with the lowest mean intensity indicated individual QDs, while the peak value of higher-order aggregates was the product of the order number and the distribution peak value of an individual QD. This relationship facilitated the differentiation of different QD aggregates and individual QDs based on their photothermal spot intensity distribution. To perform the analysis, we employed a Gaussian Mixture Model (GMM) with the iterative Expectation-Maximization (EM) algorithm to fit the histogram (e.g., histogram in panel (c)). Our results revealed that the photothermal signal of a single DN 800 QD measured 159.6±65.3 μV, representing 80.0% of the 77 spots. Furthermore, aggregates of two QDs generated a photothermal signal of 352.7±25.0 μV (9.5% of the spots), aggregates consisting of three QDs exhibited a photothermal signal of 483.7±28.2 μV (6.6% of the spots), and four QDs exhibited a photothermal signal of 637.5±28.8 μV (3.9% of the spots). The photothermal spots primarily corresponding to individual QDs, constituted 80% of the total observed spots, while higher-order DN 800 QD aggregates showed diminishing proportions as the order number increased. Moreover, aggregates with more than four QDs were scarce on the microtoroid surface (panel (b)). The individual heat dissipation of DN800 QDs, as outlined in Table 1 (see also Appendix), is calculated to be 71.25 pW, corresponding to a photothermal signal of 159.6 μV in the histogram (panel (c)). This results in a photothermal sensitivity to heat dissipation of 2.24 μV/pW. Within the histogram, the minimum recorded photothermal spot intensity is 40.2 μV, indicating a heat dissipation of 17.9 pW. The noise floor, measured at 1.688 μV (see Appendix), establishes the minimum detectable heat dissipation in the photothermal map at 0.75 pW. It is noteworthy that detecting such small QDs using SEM would be difficult due to the presence of other contaminant particles that would make the QDs hard to find. In FLOWER based photothermal microscopy, such particles remain invisible due to their low absorption at 405 nm.

TABLE 1
Optical Properties of Qdot 800 and DN 800 QDs.

| | | Molar | Absorption | | | |
|---|---|---|---|---|---|---|
| | | extinction | cross | Fraction of | Absorbed | Heat |
| | Quantum | coefficient | section | heat | Power | dissipation |
| | yield | (M⁻¹ cm⁻¹) | (nm²) | dissipation | (pW) | (pW) |
| Qdot 800 | 62% | 8.0 × 10⁶ | 3.0599 | 68.34% | 531.35 | 363.10 |
| DN 800 | 15.64% | 1.28 × 10⁶ | 0.4896 | 92.80% | 77.38 | 71.25 |

To further evaluate the discriminating capabilities of photothermal microscopy for different particles, we applied a mixture of DN 800 and Qdot 800 QDs to the microtoroid surface. The resulting photothermal image of the entire microtoroid is presented in panel (d) of FIG. 4 (size:18-20 nm; scale bar, 10 μm), with a finer photothermal image of the left part shown panel (e) (scale bar, 5 μm). Panel (e) exhibits photothermal spots with varying intensities, where strong photothermal spots correspond to Qdot 800 QDs and weaker spots represent DN 800 QDs, based on their cross-section absorption characteristics detailed in Table 1. To quantitatively analyze the photothermal spots, we constructed a histogram of photothermal spot intensities in panel (f) and employed the same fitting methodology to identify five Gaussian distribution peaks (dashed curve). Specifically, photothermal spots from single Qdot 800 QDs exhibited an intensity of 1696.5±793.7 μV, constituting 21.0% of the 327 spots. In comparison, the photothermal signal from single DN 800 QDs was measured to be 316.8±99.9 μV, accounting for 31.3% of the spots. The photothermal signal of single DN 800 QDs differs between panel (c) and panel (f), primarily due to sensitivity variations resulting from the microtoroid's pillar size. The smaller supporting pillar corresponding to panel (d) provides better thermal isolation, contributing to enhanced PT sensitivity. Moreover, two DN 800 QD aggregates displayed a photothermal signal of 653.2±153.3 μV (36.3% of the spots), while three DN 800 QD aggregates exhibited a photothermal signal of 942.7±39.8 μV (5.4% of the spots). Additionally, four DN 800 QD aggregates demonstrated a photothermal signal of 1219.3±69.0 μV (6.0% of the spots). Consequently, the photothermal signal ratio of Qdot 800 QDs to DN 800 QDs was approximately 5.36. Remarkably, this experimental photothermal signal ratio for single QDs closely corresponds to the theoretically calculated heat dissipation values detailed in Table 1, exhibiting a difference of merely 5.2%.

Employing this analysis of photothermal intensity, we selected a single DN 800 QD on the microtoroid for high-resolution scanning (x direction: 75 nm/pixel, y direction: 9.375 nm/pixel). The resulting photothermal image (with background signal removed) is presented in panel (g) of FIG. 4 (scale bar, 1 μm). Panel (h) represents profile cuts through the photothermal peak of the single QD in the x and y directions. Typically, after performing a high-resolution photothermal spot scan and adjusting the microtoroid position to match the pump laser's focal point, photothermal peak intensities will increase compared to the fine photothermal map of multiple spots. In panel (g), the photothermal peak's value measures 186.26 μV. For a single DN 800 QD (size: 5-6 nm), this yields a SNR of 1.17×10⁴. Calculations based on the experimental setup information establish the heat dissipation of a single 5 nm DN 800 QD at 71.25 pW. The high SNR observed in the context of a single 5 nm QD using our photothermal microscopy underscores our potential to detect single small molecules.

As illustrated, FLOWER based photothermal microscopy using re-etched microtoroids can detect single nanoparticles, as small as 5 nm QDs, with a SNR exceeding 10⁴. The detection limits in terms of heat dissipation of FLOWER based photothermal microscopy was determined to be 0.75 pW, more than two orders of magnitude smaller than the 0.34 nW heat dissipation power reported for single dye molecules in photothermal detection. This provides compelling evidence of our photothermal microscopy's ability to detect single molecules. The significant advancement in detection limits is attributed to the enhancement in photothermal sensitivity. Despite the higher photothermal sensitivity of the toroid area, we deliberately selected the photothermal disk area for detecting QDs and measure their absorption based on the photothermal signal. This choice was influenced by the Fano resonance spectra exhibited by nano-particles in the toroid area, which could affect their intrinsic absorption measurements. By choosing the disk area near the toroidal rim area, we maintained high photothermal sensitivity with minimal differences, allowing accurate measurement of the nanoparticle's absorption based on the photothermal signal. The 2D photothermal image generated through a galvo mirror scan enabled detailed visualization of the absorption properties and specific binding locations of the target nanoparticles on the microtoroid surface. Unlike fluorescence techniques, the photothermal signal arises from the heat dissipation of absorbed light, thereby enabling the detection of non-luminescent materials in the photothermal microscope. Nonetheless, fluorescence images still served as valuable references for photothermal mapping. The detection of single-step quantum blinking behavior from STORM and the intensity distribution of photothermal spots further validated the identification of individual QDs rather than aggregates.

Further improvements can be achieved by, for instance, increasing the phase modulation frequency and adjusting the AM frequency accordingly to reduce the response time and acquisition time of a photothermal image. Moreover, spectroscopy measurements by varying the pump laser's wavelength or exciting it with different wavelengths can enable multicolor imaging. The integration of photothermal microscopy with WGM resonators can enable real-time observation of dynamic changes and interactions of target molecules. We believe that overall, FLOWER based photothermal microscopy represents a versatile platform for label-free imaging and single-molecule detection. The demonstrated high sensitivity and discrimination capabilities pave the way for advancements in nanoscale imaging and characterization techniques.

### Example Fabrication of the Re-Etched Microtoroid

Example microtoroid resonators can be fabricated on silicon wafers with a 2 μm layer of thermally grown silica. First, circular disc patterns of photoresist with a diameter of 100 μm are created on the top silica layer of the silicon wafer. These photoresist circular pads act as etch masks during immersion in a buffered oxide etchant solution (1:6 VN) at room temperature, which contains HF (7-15%). After wet etching, any residual photoresist and contaminants are removed using acetone and isopropyl alcohol (IPA). The wafer is then subjected to a post-bake at 130° C. to remove moisture. The remaining silica disks act as etch masks during exposure to xenon difluoride (XeF₂) gas, resulting in the uniform undercutting of the silica disks and the formation of silicon pillars that support the silica disks. A thermal reflow process using a CO₂ laser is employed to shape the silica disk into a microtoroid. Subsequent re-etching of the microtoroid using XeF₂ gas is performed to decrease the diameter of the supporting pillars to meet the requirements of the experiment.

### Example Au Nanosphere Binds on the Microtoroid.

A 100 nm Au nanosphere solution (nanoComposix) was diluted 100 times with HPLC-grade deionized water to achieve a concentration of 5 μg/mL. The diluted Au nanosphere solution was then injected into an aerosol generator. The aerosol generator includes a dryer that removes the liquid water from the Au nanosphere aerosol, resulting in dry aerosol particles. To perform the spraying process, the microtoroid chip was positioned approximately 1 cm below the aerosol output nozzle in a fume hood. This allowed the Au nanospheres to bind on the microtoroid surface.

### Example Quantum Dots Functionalization on the Microtoroid Surface

After the fabrication of the re-etched microtoroid, the microtoroid chip was cleaned with ethanol and dried by nitrogen gas spray to remove any potential contaminations. The microtoroid chip was then treated with a solution containing 2% v/v of 3-aminopropyl-triethoxysilane (APTES) and ethanol for amine functionalization. The chip was incubated in this solution for 2 minutes at room temperature. After the incubation, the microtoroid chip was rinsed with fresh ethanol and IPA, followed by drying using a flow of nitrogen gas. Next, a mixed QDs solution was prepared with 100 mM1-ethyl-3-(3-dimethylaminopropyl) carbodiimide (EDC) and 100 mM N-Hydroxysulfosuccinimide sodium salt (sulfo-NHS) in 0.1 M 2-(N-morpholino) ethanesulfonic acid (MES) buffer (pH=6.7). The microtoroid chip was then placed in the mixed QDs EDC/NHS solution and incubated for 15 minutes at room temperature. During this incubation, the carboxyl functionalized QDs was bound to the microtoroid surface through the formation of an amide bond. After incubation, the chip was thoroughly rinsed with MES buffer, phosphate-buffered saline (PBS) buffer, deionized water, and ethanol to remove any unreacted reagents or residues. Finally, the chip was dried using nitrogen.

### Example Fitting Procedure.

Spot intensity histograms were analyzed using a Gaussian Mixture Model (GMM) which is a parametric probability density function that combines multiple Gaussian component densities with different weights. The histogram was fitted with various numbers of Gaussian components in the GMM using the Expectation-Maximization algorithm. To evaluate the fitting performance, the mean value of each peak was examined. It is expected that the mean values of the peaks are the product of the order number and the first peak mean value. After evaluation, it was determined that a GMM with four Gaussian components provided the best fit for the histogram in panel (c) of FIG. 4. For the mixed QDs histogram in panel (f) of FIG. 4, the same methodology is applied, resulting in the identification of five Gaussian distributions.

### Example STORM Fluorescence Image Configuration and Procedure

A N-STORM 5.0 system was used with a CFI HP Apochromat 100X AC TIRF 1.49 NA objective (Nikon) and a 20 mW 405 nm laser unit (LU-NV, Nikon). Following the application of an AT-Qdot 800 filter set (Chroma), the fluorescence signal was captured using a back-illuminated EMCCD (electron-multiplying charge-coupled device) camera (iXon Ultra 897; Andor). The microtoroid chip was imaged in a dry state, positioned upside down on a MatTek dish with a coverslip bottom, and maintained at a room temperature of 22° C. At least 1900 images were acquired to generate the STORM video.

In one example, a photothermal microscopy system is provided that includes a photodetector, a fiber beam splitter spaced apart from said photodetector, a first optical fiber having a first end optically coupled to said fiber beam splitter and a second end optically coupled to said photo detector, an optical resonator disposed proximate said first optical fiber along a side of said first optical fiber between said first and second ends, said optical resonator having an optical whispering-gallery mode and being optically coupled to said first optical fiber through an evanescent field to excite said optical whispering-gallery mode, a second optical fiber having a first end optically coupled to said fiber beam splitter and a second end optically coupled to said photo detector and being spaced away from said optical resonator to avoid being optically coupled to said optical resonator so as to provide a reference optical path, a phase modulator arranged with an optical path to said fiber beam splitter, a probe laser arranged to couple light into said phase modulator such that phase modulated light is coupled into said fiber beam splitter, said probe laser being a frequency-tunable laser, a dither electrical circuit in electrical communication with said probe laser and said photodetector so as to multiply electrical signal output from said photodetector and time averaging to provide an error signal, a PID controller configured to communicate with said probe laser and said dither electrical circuit to provide a feedback control loop with said probe laser to minimize said error signal, an objective lens system arranged with a focus that intercepts at least a portion of said optical resonator, and a pump laser arranged with said objective lens system in an optical path thereof so as to illuminate at least a portion of said optical resonator with pump light. In the photothermal microscopy system, said pump light is at a laser frequency different from said probe light so as to avoid coupling pump light into said optical resonator, said pump light is at a laser frequency that causes heating of a particle of interest when attached to said optical resonator thereby causing heating of said optical resonator, said pump light is modulated with a low amplitude (<2 kHz) modulation frequency, a change of said modulation frequency is detected to determine a presence of said particle of interest at said focus, the signal readout is from the PID controller output signal, and the microtoroid used has a small pillar (<10 microns).

For example, said first optical fiber comprises at least a portion thereof that is tapered. For example, the system further includes a pump light scanning system arranged in said optical path between said pump laser and said objective lens system. For example, said pump light scanning system comprises a Galvo Mirror and a relay lens system.

One aspect of the disclosed embodiments relates to a photothermal microscopy system that includes an optical resonator configured to operate in a whispering gallery mode (WGM) and configured to accommodate a particle of interest, the optical resonator including a pillar below a top section of the optical resonator, the pillar formed from a different material than the top section of the microtoroid optical resonator. The photothermal microscopy system also includes a pump laser operable to produce a modulated pump laser light with a first wavelength for illuminating at least a portion of the optical resonator, wherein the pump laser light has an amplitude modulation frequency that is less than 1000 Hz, and a probe laser configured to provide probe laser light with a second wavelength for coupling into the optical resonator, the second wavelength being different than the first wavelength. The a photothermal microscopy system further includes a photodetector positioned to receive light from the microtoroid optical resonator and produce electrical signals or information corresponding to the light received thereon, and a proportional-integral-derivative (PID) controller communicatively coupled to the photodetector to receive the electrical signals or the information from the photodetector, the PID controller further communicatively coupled to the probe laser, wherein an output of the PID controller includes information indicative of shifts in resonance frequency of the optical resonator in response to illumination of the optical resonator with the amplitude modulated laser light.

In one example embodiment, the pillar has diameter that is less than 20 microns and comprises silicon. In another example embodiment, the optical resonator is a microtoroid optical resonator. According to another example embodiment, the first wavelength is within a range of absorption wavelengths of the particle of interest, and the second wavelength is outside the range of absorption wavelengths. In yet another example embodiment, the first wavelength is within an ultraviolet or visible range of wavelengths, and the second wavelength is in an infrared range of wavelengths. In still another example embodiment, the amplitude modulation frequency is between 200 Hz and 300 Hz.

In some example embodiments, the photothermal microscopy system of claim 1 includes a dither circuit, a mixer circuit, a polarization controller, a phase modulator, a beam splitter and an interferometer, wherein: the dither circuit is coupled to the polarization controller and the mixer circuit, the mixer circuit is coupled to the photodetector and the PID controller, the phase modulator is configured to modulate a phase of the probe laser light, the polarization controller is coupled to the phase modulator and the interferometer, and the interferometer is coupled to the photodetector and configured to incorporate at least a part of the optical resonator. In another example embodiment, the photodetector is a balanced photodetector, and the dither circuit is configured to produce a dither signal that, when multiplied by an output of the balanced photodetector, produces an error signal that is proportional to a wavelength detuning between the probe laser light and a resonance of the optical resonator. In still another example embodiment, the photothermal microscopy system includes a lock-in-amplifier (LIA) coupled to the PID controller, and a signal generator configured to generate a signal at the amplitude modulation frequency and coupled to LIA and to the pump laser.

In one example embodiment, the photothermal microscopy system includes an optical scanner system operable to change a direction of the modulated pump laser light to allow illumination of different areas of the optical resonator by the modulated pump laser light. In another example embodiment, the photothermal microscopy system includes one or more objective lenses, wherein the optical scanner system includes a galvo mirror configured to produce a scanning modulated pump laser light that is delivered to the top section of the optical resonator through the one or more objective lenses.

In some example embodiments, the particle of interest comprises one or more quantum dots. In another example embodiment, the particle of interest is a nanosphere. In yet another example embodiment, the particle of interest is a quantum dot or a nanosphere having a diameter in a range of 5 nm to 100 nm. In still another example embodiment, the microtoroid optical resonator has a Q-factor with an order of magnitude of 10⁶. In yet another example embodiment, the photothermal microscopy system is configured to produce a photothermal signal-to-noise ratio with an order of magnitude of 10⁴.

In another example embodiment, a detector system for use in a photothermal microscopy system is described. The detector system includes a microtoroid optical resonator configured to operate in a whispering gallery mode (WGM) and configured to accommodate a particle of interest; the microtoroid optical resonator includes a pillar below a top surface of the microtoroid optical resonator, the pillar formed from a different material than the top surface of the microtoroid optical resonator. In the detector system at least a portion of the microtoroid optical resonator is positioned to receive a modulated pump laser light with a first wavelength and an amplitude modulation frequency that is less than 1000 Hz, and the microtoroid optical resonator is configured to receive a probe laser light with a second wavelength, the second wavelength being different than the first wavelength. The detector system also includes a photodetector positioned to receive light from the microtoroid optical resonator and produce electrical signals or information corresponding to the light received thereon, and a proportional-integral-derivative (PID) controller communicatively coupled to the photodetector to receive the electrical signals or the information from the photodetector, wherein an output of the PID controller includes information indicative of shifts in resonance frequency of the microtoroid optical resonator in response to illumination of the microtoroid optical resonator with the amplitude modulated laser light.

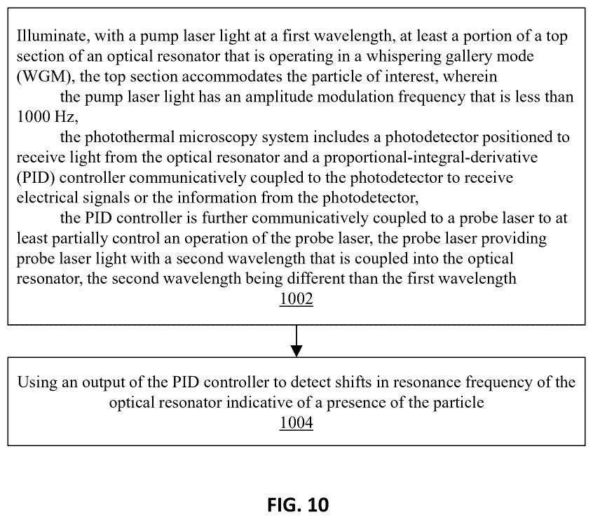

FIG. 10 illustrates a set of operations that can be carried out to detect a particle in a photothermal microscopy system in accordance with an example embodiment. At 1002, using a pump laser light at a first wavelength, at least a portion of a top section of a optical resonator that is operating in a whispering gallery mode (WGM) is illuminated; the top section accommodating the particle. The pump laser light has an amplitude modulation frequency that is less than 1000 Hz, the photothermal microscopy system includes a photodetector positioned to receive light from the optical resonator and a proportional-integral-derivative (PID) controller communicatively coupled to the photodetector to receive electrical signals or the information from the photodetector, the PID controller further communicatively coupled to a probe laser to at least partially control an operation of the probe laser, the probe laser providing probe laser light with a second wavelength that is coupled into the optical resonator, the second wavelength being different than the first wavelength. At 1004, using an output of the PID controller, shifts in resonance frequency of the optical resonator indicative of a presence of the particle are detected.

In one example embodiment, the above noted method includes scanning different areas of the top section of the optical resonator using the modulated pump laser light. In another example embodiment, the particle of interest is positioned at a peripheral location on a top surface of the optical resonator. In yet another example embodiment, the first wavelength is within a range of absorption wavelengths of the particle of interest, and the second wavelength is outside the range of absorption wavelengths. In still another example embodiment, the above method includes detecting a photothermal response associated with the optical resonator using a control-loop signal in response to illumination of the optical resonator.

At least part of the operations disclosed embodiments may be implemented using a system that includes at least one processor and/or controller, at least one memory unit that is in communication with the processor, and at least one communication unit that enables the exchange of data and information, directly or indirectly, through the communication link with other entities, devices, databases and networks. Such processors, controllers, and the associated memory and communication unit can be incorporated as part of the computer. The communication unit may provide wired and/or wireless communication capabilities in accordance with one or more communication protocols, and therefore it may comprise the proper transmitter/receiver, antennas, circuitry and ports, as well as the encoding/decoding capabilities that may be necessary for proper transmission and/or reception of data and other information. For example, the processor and memory may be used to conduct computations, to control the operation of various components, to receive or transmit information from or to the disclosed components.

The processor(s) may include central processing units (CPUs) to control the overall operation of, for example, the host computer. In certain embodiments, the processor(s) accomplish this by executing software or firmware stored in memory. For example, the processor may be programmed to process the information that it obtained from the polarization cameras to obtain a phase difference or a depth measurement. The processor(s) may be, or may include, one or more programmable general-purpose or special-purpose microprocessors, digital signal processors (DSPs), programmable controllers, application specific integrated circuits (ASICs), programmable logic devices (PLDs), graphics processing units (GPUs), or the like, or a combination of such devices.

The memory represents any suitable form of random access memory (RAM), read-only memory (ROM), flash memory, or the like, or a combination of such devices. In use, the memory may contain, among other things, a set of machine instructions which, when executed by processor, cause the processor to perform operations to implement certain aspects of the presently disclosed technology.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Various information and data processing operations described herein may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media that is described in the present application comprises non-transitory storage media. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Only a few implementations and examples are described and other implementations, enhancements and variations can be made based on what is described and illustrated in this patent document.

Additional details and examples associated with the disclosed technology are described in the Appendix below.

### APPENDIX

### Example Configuration of FLOWER Based Photothermal Microscopy

Our photothermal microscopy system is constructed based on an optical sensing system known as FLOWER (frequency locked optical whispering evanescent resonator). FLOWER tracks the resonance shift of an optical microcavity using frequency locking. FIG. 1a shows a schematic of FLOWER based photothermal microscopy. A tunable external cavity diode laser (New Focus TLB-6712-P Velocity™) is employed as the probe laser. The probe laser output is connected to a lithium niobate phase modulator (IXblue NIR-MPX800-LN-0.1), which is driven by a 25 MHz oscillation dither signal. A polarization controller (PC) and a 50:50 fiber beam splitter (BS) are utilized to manipulate the phase-modulated probe laser. The PC is responsible for controlling the polarization of the probe laser to maximize the coupling efficiency between the microtoroid and tapered fiber. The BS splits the light into signal and reference arms, which are input separately into a high bandwidth balanced photodetector (New Focus Model 1807). In the signal arm, an optical fiber is thermally tapered using a hydrogen torch to achieve a diameter of approximately 1 μm, ensuring enhanced coupling efficiency. The microtoroid optical resonator is evanescently coupled to the system through the tapered signal arm fiber. The output signal from the balanced receiver is multiplied by the dither signal and then time-averaged, resulting in the generation of an error signal as depicted in panel (b) of FIG. 2. This error signal is proportional to the wavelength detuning between the laser and the microtoroid resonance. To control the laser wavelength, a proportional-integral-derivative (PID) controller is used. The PID controller receives the error signal and provides feedback to the probe laser controller to bring the absolute value of the error signal toward zero. Consequently, the probe laser wavelength is locked precisely at the whispering gallery mode (WGM) resonance wavelength of the microtoroid. By monitoring the output of the PID controller, the resonance wavelength shifts can be accurately measured.

Based on the FLOWER system, a continuous wave (CW) laser (Thorlabs S3FC405) is utilized as the pump laser for particle excitation. To generate a high photothermal signal, a 405 nm wavelength is chosen as the excitation wavelength, as many molecules and particles exhibit characteristic absorptions in the UV spectrum. The pump laser is subjected to amplitude modulation (AM) using the input signal derived from the function generator. The output of the fiber-coupled pump laser is converted into a free-space beam using a fiber collimator. This collimated pump beam is directed toward a mirror that is mounted on the galvo driver. As the galvo mirror rotates, the angle of incidence of the collimated beam varies at the back focal plane of the relay lenses. The reflected beam then passes through relay lenses, comprising a scan lens (f=100 mm) and a tube lens (f=100 mm). Subsequently, the beam is guided into a 60× objective lens via a cubic beam splitter. The free-space pump laser is focused onto the top surface of the microtoroid. The magnitude of the oscillation in the resonance shift, referred to as the photothermal signal, is directly linked to the heat dissipation resulting from the pump laser. To accurately measure the photothermal signal, a lock-in amplifier (Stanford Research Model SR830) is employed, operating at the frequency of the AM. By utilizing this double lock-in technique, an enhanced signal-to-noise ratio (SNR) of the photothermal image is achieved through a 2D scan of the pump laser.

To mitigate potential damage to the integrated fiber-coupled laser caused by response delays in the constant power control loop, we avoid square wave or TTL modulation applied to the pump laser. Instead, sinusoidal wave AM is employed in the modulation input of the laser. The chosen AM frequency is set at 203.7 Hz. The selection of the modulation frequency requires a careful balance between three objectives: minimizing noise, maximizing the photothermal response of the microresonators, and minimizing the photothermal response time. Low-frequency technical noise, specifically 1/f noise, tends to increase at lower frequencies. By gradually increasing the modulation frequency, the spectral density of 1/f noise can be reduced. However, the re-etched microtoroid exhibits a limited bandwidth of 400 Hz for AM in the photothermal heating signal. The photothermal response time decreases as the AM frequency increases. Taking all these factors into consideration, a reasonable range for choosing the AM signal falls between 200 Hz and 300 Hz. This range strikes a balance among minimizing noise, maximizing photothermal response, and optimizing the photothermal response time.

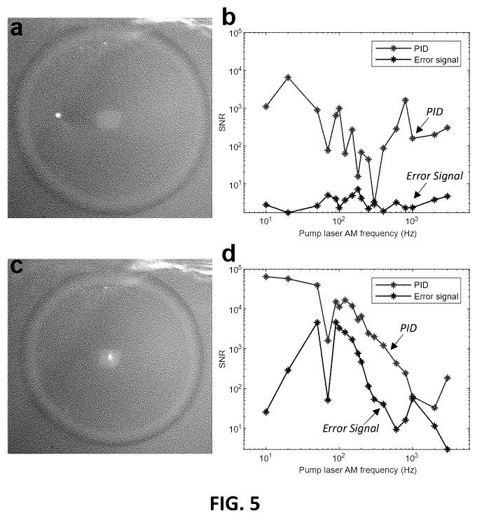

In our example photothermal microscopy configuration, we have two viable options as signal source for the lock-in amplifier: the PID output signal, used as feedback for tuning the probe laser, and the error signal, which is linearly proportional to the detuning of the microtoroid resonance from the probe laser wavelength. FIG. 5 provides a comparison of the SNR for these two photothermal signal sources. Notably, in panel (a) the pump laser spot is focused on the microtoroid disk area; panel (b) shows the comparison of the SNR between the two photothermal signal sources (either from the PID or from the error signal) for a small photothermal response (at the disk). Panel (c) shows the pump laser spot that is focused on the microtoroid pillar and panel (d) shows a comparison of the SNR between the two photothermal signal sources for a large photothermal response (at the pillar). In panels (b) and (d), the two curves respectively illustrate the PID output signal and the error signal that is input to lock-in amplifier. The R output of the SR830 lock-in amplifier serves as the photothermal signal, which represents the amplitude of the oscillating resonance shift signal at the AM frequency. In this context, SNR is defined as the ratio of the power of the photothermal signal to the power of the background noise.

The microtoroid structure consists of a silica disk supported by a small silicon pillar. When the pump laser scans the bare microtoroid's disk area, the photothermal signal is low due to the low optical absorption of the glass. However, when the pump laser scans the microtoroid pillar, the photothermal signal is high due to the large heat dissipation from the silicon pillar. This leads to a low background signal on the disk and a high background signal on the pillar. Therefore, the effective detection area is the microtoroid disk excluding the pillar.

In panel (b) of FIG. 5 that corresponds to the panel (a) example, for small photothermal responses, the SNR of the PID photothermal response is generally higher than that of the error signal photothermal response, except at an AM frequency of 180 Hz. This abnormal decrease in SNR at 180 Hz may be attributed to increased AM noise in the pump laser caused by issues with the laser control circuit. The SNR of the error signal remains below 10 at 180 Hz, resulting in a less noticeable decrease in SNR. A similar abnormal dip in SNR is observed at 70 Hz in FIG. S1d, for both the PID and error signal photothermal responses. In panel (d) which corresponds to the panel (c) example, for large photothermal responses, the SNR of the PID photothermal response is also higher than that of the error signal photothermal response. Choosing an AM frequency of 203.7 Hz strikes a balance between photothermal SNR and response time. At this frequency, both for large and small photothermal responses, the PID method exhibits a 10 times higher SNR compared to the error signal method. Therefore, the PID photothermal response is more suitable for the re-etched microtoroid.

The re-etched microtoroid, with its small pillar, provides better thermal isolation, resulting in reduced heat dissipation conducted through the pillar to the chip substrate. This improved thermal isolation enhances the sensitivity of the photothermal response. However, it also decreases the microtoroid's AM cutoff bandwidth from 4 or 5 kHz to 400 Hz. When the pump laser operates at low-frequency AM, the probe laser effectively tracks the microtoroid resonance, resulting in a consistently low detuning between their wavelengths. Consequently, the error signal exhibits low sensitivity to the photothermal response. Conversely, the PID output signal is highly sensitive to the photothermal response because it controls the probe laser wavelength. Therefore, for the re-etched microtoroid, the PID photothermal response is a better choice than the error signal method.

### Cross-Section Absorption of Au Nanosphere Examples

The absorption cross section σ_{Au} of individual Au nanoparticles is determined based on the Mie theory absorption model,

$${σ}_{Au} = \frac{2 π}{λ} Im \{ α \} , \qquad ( 1 )$$

where λ is the wavelength of illuminating light, the corrected polarizability α is

$$α = 3 V \frac{1 - ( ε + {ε}_{m} ) {θ}^{2} / 10}{\frac{ε + - 2 {ϵ}_{m}}{ε - {ϵ}_{m}} - \frac{( ε + 10 {ϵ}_{m} ) {θ}^{2}}{10} - i \frac{2 {ϵ}_{m}^{3 / 2} {θ}^{3}}{3}} \qquad ( 2 )$$

where

$$θ = \frac{2 π {r}_{Au}}{λ}$$

is the size parameter and r_{Au} is the Au nanosphere radius. The relative permittivity ϵₘ is approximately 1 in air. The relative permittivity of Au nanosphere, ε, is taken from Johnson and Christy's report.

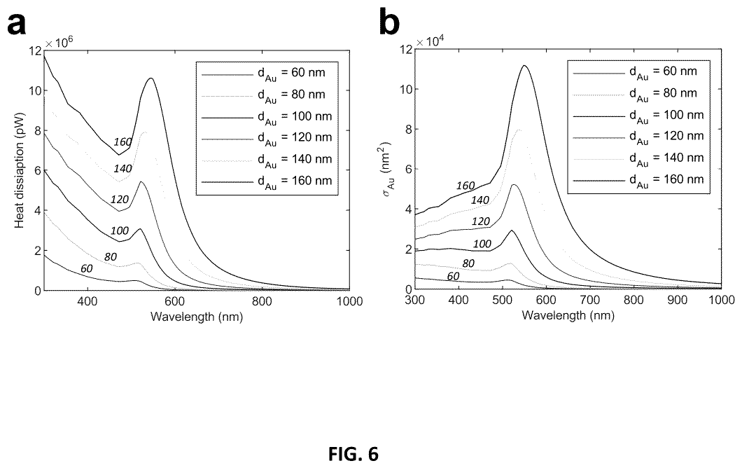

FIG. 6 illustrates calculated optical and thermal properties of gold nanospheres. Panel (a) illustrates the absorption cross section of gold nanospheres with varying diameters ranging from 60 nm to 160 nm. At 405 nm, the absorption cross section of 100 nm gold nanosphere is σ_{Au}=1.9739×10⁴ nm². Panel (b) shows the heat dissipation of the Au nanospheres of panel (a). The heat dissipation of the 100 nm Au nanosphere mentioned above under a 405 nm pump laser Pₕₑₐₜ=3.4277×10⁻⁶ W=3.4277×10⁶ pW.

FIG. 6, panel (a), shows the absorption cross section σ_{Au} of a gold nanosphere. The diameter of the nanospheres ranges from 60 nm to 160 nm. Notably, the absorption cross section exhibits a peak at around 520 nm. As the size of the Au nanospheres increases, the absorption cross section σ_{Au} consistently demonstrates an upward trend. In our experiments we used a 100 nm Au nanosphere as our first test particle. The absorption cross section of 100 nm Au nanosphere is σ_{Au}=1.9739×10⁴ nm² at 405 nm. These absorption cross section results provide insight into the optical properties of the Au nanosphere.

To calculate the heat dissipation of the Au nanosphere, it is essential to determine the intensity of the pump laser spot. The diameter of the pump laser can be calculated using the Rayleigh criterion, which states that:

$${d}_{spo𝔱} = 1.22 \times \frac{λ}{NA} , \qquad ( 3 )$$

where the pump laser wavelength λ=405 nm, and NA is the numerical aperture of the pump light illumination system. The spot intensity is:

$${I}_{0} = \frac{{P}_{0}}{{S}_{spot}} = \frac{4 {P}_{0}}{π {d}_{spo𝔱}^{2}} , \qquad ( 4 )$$

where P₀ is the power of the laser spot focused on the microtoroid top surface. The 405 nm pump laser spot intensity is 17.4 KW/cm². The target particle absorbed power equals to the heat dissipation of the Au nanosphere,

$${P}_{heat} = {P}_{abs} = {I}_{o} {σ}_{au} \qquad ( 5 )$$

The heat dissipation of the Au nanosphere is calculated based on its absorption cross section, as shown in panel (a) of FIG. 6, using Eq. (5). The heat dissipation of the Au nanosphere under 405 nm pump laser excitation is illustrated in panel (b) of FIG. 6. Specifically, for a 100 nm Au nanosphere, the heat dissipation is calculated to be Pₕₑₐₜ=3.4277×10⁻⁶ W=3.4277×10⁶ pW under a 405 nm pump laser. The microtoroid has the capability to detect heat dissipation power of a few tens of pW. Therefore, the 100 nm Au nanosphere exhibits a significant photothermal response making it easily detectable.

### Example Characterizations of QDs

When considering luminescent particles as the target, the absorption calculation presents a different scenario, as a portion of the absorbed light energy is transferred to emitted light. In this case, the fraction of heat dissipation in fluorescence particles is:

$${η}_{heat} = 1 - {η}_{fl} + \frac{{η}_{fl} ( \frac{1}{{λ}_{exc}} \frac{1}{{λ}_{fl}} )}{\frac{1}{{λ}_{exc}}} = 1 - {η}_{fl} \frac{{λ}_{exc}}{{λ}_{fl}} , \qquad ( 6 )$$

where η_{fl} is the quantum yield of the fluorescence particle, λ_{exc} is the excitation wavelength, and λ_{fl} is the emission wavelength. The absorbance of the fluorescence particle solution was measured using a Nanodrop. According to the Beer-Lambert law, the molar extinction coefficient εₑₓₜ is calculated in units M⁻¹cm⁻¹,

$${ε}_{ext} = \frac{A}{cl} , \qquad ( 7 )$$

where A is the absorbance of the fluorescence particle solution, c is the molar concentration of the absorbing particles, l is the path length of the sample solution in unit cm. The cross-section absorption σ_{abs} is in unit cm², and can be calculated by,

$${σ}_{abs} = {ε}_{ex𝔱} \times 1 {0}^{- 1} \times ln ( 10 ) / {N}_{A} \qquad ( 8 )$$

in unit of nm², where the Avogadro constant, N_{A}=6.02×10²³. Finally, the heat dissipation is,

$${P}_{heat} = {P}_{abs} \times {η}_{heat} \qquad ( 9 )$$

The Qdot 800 QDs, supplied by Thermo Fisher Scientific have a diameter ranging from 18 nm to 20 nm. According to the certificate of analysis, these QDs have a quantum yield of 62% and emit light at a wavelength of 793 nm. On the other hand, the quantum yield of DiagNano 800 QDs, supplied by CD Bioparticles, was not provided, so it was determined by comparing the emission intensity of DiagNano 800 with that of Qdot 800,

$${η}_{2} = \frac{{I}_{2}}{{ε}_{2}} \times \frac{{ε}_{1}}{{I}_{1}} \times {η}_{1} , \qquad ( 10 )$$

where η is the quantum yield, ε is the molar extinction, I is the fluorescence emission intensity, with subscripts 1 and 2 representing DiagNano 800 and Qdot 800, respectively. The fluorescence emission intensities of the QDs were measured in the fluorescence image. The quantum yield of DiagNano 800 QDs was calculated to be 15.64%. These nanoparticles have a diameter ranging from 5 nm to 6 nm and exhibit similar fluorescence properties to Qdot 800, emitting light at a wavelength of 800 nm. The characteristic information of the two QDs used in the photothermal map is presented in Table 1. The heat dissipation of Qdot 800 is 363.1 pW, while the heat dissipation of DiagNano 800 is 71.25 pW. The ratio of their heat dissipation is approximately 5.10. In the experiment, the photothermal response ratio between the two QDs is approximately 5.36. The photothermal response is proportional to the heat dissipation. Therefore, the photothermal response ratio should remain consistent with the heat dissipation ratio.

### Example WGM Resonance Shift COMSOL Simulation

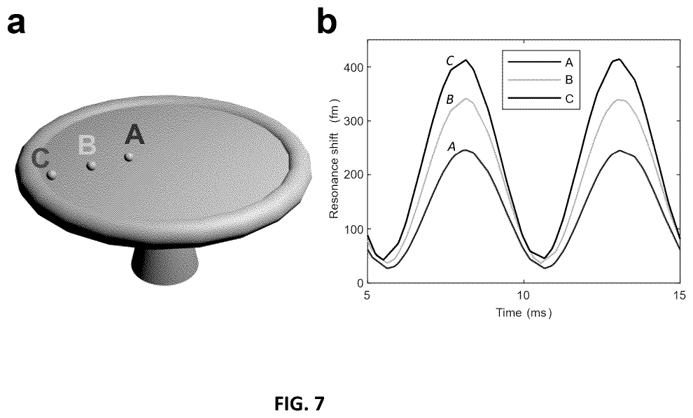

The photothermal response is characterized by an oscillating resonance shift signal resulting from the absorption of the AM pump laser by the target particle. In COMSOL simulation, the 100 nm Au nanoparticles serve as the heating source, with previously calculated heat dissipation of 3.4277×10⁶ pW using the experimental 405 nm pump laser. The pump laser spot size is larger than the size of the target particles. As a result, a significant portion of the light illuminates the top surface of the microtoroid. Since silica material exhibits minimal absorption, the light absorbed by the silica microtoroid can be neglected compared to the absorbed light by the particles. Most of the pump light is absorbed by the nontransparent silicon chip substrate, which is significantly larger in size compared to the microtoroid (with a major diameter of approximately 100 μm). Most of the heat dissipation in the substrate readily conducts throughout the entire chip substrate. However, due to the small diameter (below 5 μm) of the microtoroid's silicon pillar, the contribution of heat dissipation from the chip substrate to the photothermal signal is minimal. The simulation employs the finite-element analysis method. In the simulation, the heat dissipation process of the Au nanoparticles is simplified as point heat sources. The resonance wavelength shift signal is determined by the resonance condition of the optical resonator, which is defined by the resonance condition of optical resonator,

$${λ}_{res} = \frac{OPL}{m} \qquad ( 11 )$$

where λᵣₑₛ is the resonance wavelength, OPL is the optical path length (OPL), m is the mode number of WGM. The OPL is calculated by integrating the product of the geometric length of the optical path followed by the WGM and the refractive index of the medium. The time-dependent simulation considers both heat transfer and thermal expansion simultaneously. The microtoroid's deformation caused by the thermal expansion from the point heat source is utilized for the calculation of the geometric length. The thermo-optic coefficient (dn/dT) of fused silica at room temperature (295 K) is 8.6×10⁻⁶ K⁻¹. The refractive index information is acquired by the temperature distribution on the microtoroid rim. COMSOL simulation of the microtoroid resonance shift are shown in FIG. 7, where panel (a) illustrates the rendered model of the microtoroid with 100 nm Au nanospheres positioned on the microtoroid resonator. The microtoroid resonator has a major diameter of 70 μm and a minor diameter of 3 μm. The Au nanospheres A, B, and C are individually placed at distances of 10 μm, 20 μm, and 30 μm from the center of the microtoroid disk. Panel (b) illustrates the observed resonance shift resulting from the absorption of the 405 nm pump laser by the Au nanospheres A, B, and C shown in panel (a). In the microtoroid's disk area, the resonance shift is larger when the particle is positioned closer to the microtoroid's rim. The photothermal sensitivity of the nanoparticle exhibits a limited difference between positions B and C within the disk area (see panel (a) of FIG. 7). This limited area with a well-defined photothermal spot is suitable for measuring the particle's absorption cross section through the photothermal response.

### Example Photothermal Spot of Single QDs

For the analysis of photothermal spot intensities of individual quantum dots, the Gaussian Mixture Model (GMM) is employed photothermal spot peak distribution. This enables the assessment of the photothermal intensity distribution of the single quantum dots. Subsequently, a specific quantum dot is located and selected for a high-resolution scan (x direction: 75 nm/pixel, y direction: 9.375 nm/pixel). The dissimilarity in pixel resolution between the x and y directions arises from the microtoroid's 2D scanning procedure, which is carried out line by line along the y direction. Although the data acquisition card efficiently acquires data at a high sample rate for the y direction, the x direction is constrained by the number of scan lines. Enhancing resolution in the x direction would substantially extend the scan time. Consequently, during the scan, the pixel resolution in the y direction is design to be higher than that in the x direction due to the sample rate of the lock-in amplifier output signal.

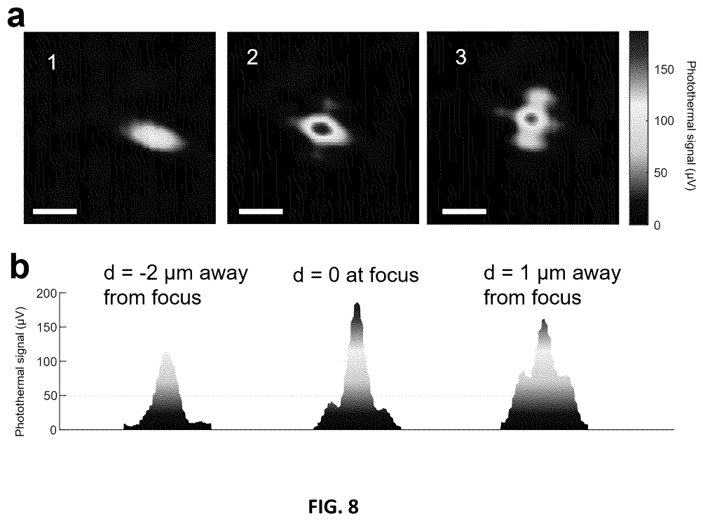

FIG. 8 illustrates photothermal mapping of a single 5-6 nm QD at different focus positions in accordance with some example embodiments. Notably, panel (a) illustrates photothermal images of the same DN 800 QD (size: 5-6 nm) with the background signal removed: with the QD positioned at d=−2 μm, out of focus and behind the focal point of the objective lens; with the QD at d=0 precisely at the focus point (sub-panel); and with the QD located at d=1 μm, appearing blurred in front of the focal point (sub-panel), with scale bar, 1 μm. Panel (b) illustrates photothermal signal profiles and scans of the same DN 800 QD at varying distances from the focal point, corresponding to the photothermal maps in sub-panels 1-3.

The results of photothermal mapping of single QDs at different focus positions are depicted in panel (a) of FIG. 8. This photothermal map undergoes background signal subtraction, effectively yielding a final photothermal map with the original photothermal signal and estimated background removed. Such subtraction enhances the visibility of significant features within the data by minimizing the influence of background noise Firstly, we create a disk-shaped structuring element, often referred to as a kernel or mask, to define a local neighborhood around each pixel in the dataset. Next, we employ the “imopen” function to execute morphological opening on this disk-shaped structuring element. Morphological opening, a mathematical morphology operation, comprises two steps: erosion followed by dilation. During erosion, the structuring element is centered over each pixel in the input data, leading to the reduction of small bright spots and an overall decrease in image intensity. Then, dilation is applied with the structuring element centered over each pixel. This step enlarges the remaining features, emphasizing large structures. As a result of these two data processing steps, we acquire the background signal. Finally, by subtracting this background dataset, photothermal maps without the background are shown in panel (a) of FIG. 8. This enables us to focus on the specific feature spots of interest, namely the photothermal spots of single QDs.

To directly illustrate the influence of focus conditions on photothermal spot intensity, panel (b) of FIG. 8 displays the profiles of the spots 1-3 with varying focus positions from panel (a). In the initial scan, it's common for the quantum dot to be off the focus plane. As seen in panel (a), the photothermal map of the first scan is depicted in panel (a-1), where the QD is positioned out of focus and behind the focal point. Here, the photothermal peak value is measured at 117.76 μV. With subsequent scans and focal plane adjustments, the photothermal map at the focus plane is presented in panel (a-2), showing photothermal peaks at 186.26 μV. In contrast, panel (a-3) portrays the quantum dot at d=1 μm, resulting in a blurred appearance in front of the focal point. Consequently, the photothermal peak value diminishes to 162.19 μV. It's important to note that the photothermal signal represents the amplitude of the oscillating resonance shift signal. The SNR of the photothermal spot is defined as the ratio of the power of the photothermal spot's peak to the power of the encompassing background noise. Under optimal focus conditions, the SNR of the photothermal spot of the 5 nm DN 800 QD culminates at an impressive 1.18×10⁴, The resulting noise floor from the photothermal map is measured at 1.6876 μV.

### STORM Fluorescence Image QDs

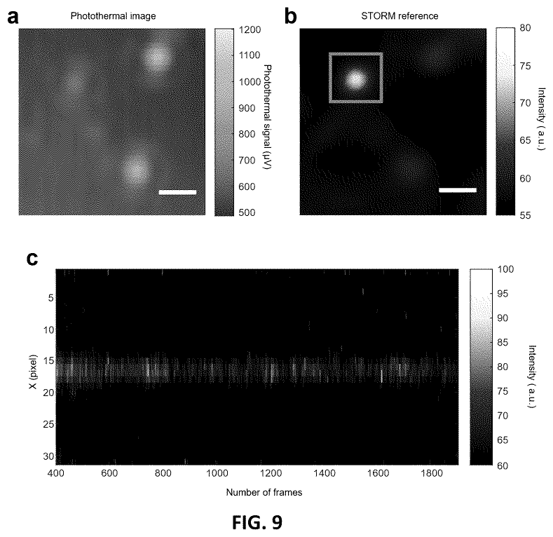

To validate the accuracy of the photothermal images of QDs, we used fluorescence images of the QDs as references for the photothermal map. FIG. 9 illustrates photothermal images of single QDs using STORM. In our experimental procedure, after functionalizing the QDs onto the microtoroid, we executed a photothermal scan of the microtoroid, yielding the results illustrated in panel (a) of FIG. where photothermal scan of Qdot 800 QDs (size:18~20 nm) is shown. Panel (b) illustrates the corresponding STORM fluorescence reference image of panel (a), and panel (c) illustrates the photo blinking behavior of single QDs within the marked square in panel (b).

In obtaining the results shown in FIG. 9, subsequent to photothermal scan of the microtoroid, the microtoroids containing the QDs were imaged using Stochastic Optical Reconstruction Microscopy (STORM). This STORM imaging involved a CFI HP Apochromat 100X AC TIRF 1.49 NA objective with a 405 nm laser for excitation. The Qdot 800 QDs (size: 18-20 nm) were successfully observed in the STORM image which is shown in panel (b). Both images reveal identical positions of the three QDs spots. A one-minute video is recorded in the STORM. The single step photon blinking was observed in the STORM video and demonstrated in panel (c). However, due to the lower quantum yield and smaller size, single DN 800 QDs (size: 5-6 nm) were not observable through STORM. In the case of DN 800 QDs bound to the microtoroid, the count of fluorescence spots was much lower compared to the spots in photothermal image. This difference can be attributed to the fact that the single DN 800 QDs can't emit sufficient light for detection through STORM. Although, there may exist some single DN 800 QDs that are observable via STORM with an extended exposure time, their emitted signals remain too weak to observe the blinking effect in a suitable exposure time.

I/We claim:

1. A photothermal microscopy system, comprising:
an optical resonator configured to operate in a whispering gallery mode (WGM) and configured to accommodate a particle of interest, the optical resonator including a pillar below a top section of the optical resonator, the pillar formed from a different material than the top section of the optical resonator;
a pump laser operable to produce a modulated pump laser light with a first wavelength for illuminating at least a portion of the optical resonator, wherein the pump laser light has an amplitude modulation frequency that is less than 1000 Hz;
a probe laser configured to provide probe laser light with a second wavelength for coupling into the optical resonator, the second wavelength being different than the first wavelength;
a photodetector positioned to receive light from the optical resonator and produce electrical signals or information corresponding to the light received thereon; and
a proportional-integral-derivative (PID) controller communicatively coupled to the photodetector to receive the electrical signals or the information from the photodetector, the PID controller further communicatively coupled to the probe laser, wherein an output of the PID controller includes information indicative of shifts in resonance frequency of the optical resonator in response to illumination of the optical resonator with the amplitude modulated laser light.

2. The photothermal microscopy system of claim 1, wherein the pillar has diameter that is less than 20 microns and comprises silicon.

3. The photothermal microscopy system of claim 1, wherein the optical resonator is a microtoroid optical resonator.

4. The photothermal microscopy system of claim 1, wherein the first wavelength is within a range of absorption wavelengths of the particle of interest, and the second wavelength is outside the range of absorption wavelengths.

5. The photothermal microscopy system of claim 3, wherein the first wavelength is within an ultraviolet or visible range of wavelengths, and the second wavelength is in an infrared range of wavelengths.

6. The photothermal microscopy system of claim 1, wherein the amplitude modulation frequency is between 200 Hz and 300 Hz.

7. The photothermal microscopy system of claim 1, comprising a dither circuit, a mixer circuit, a polarization controller, a phase modulator, a beam splitter and an interferometer, wherein:
the dither circuit is coupled to the polarization controller and the mixer circuit,
the mixer circuit is coupled to the photodetector and the PID controller,
the phase modulator is configured to modulate a phase of the probe laser light,
the polarization controller is coupled to the phase modulator and the interferometer, and
the interferometer is coupled to the photodetector and configured to incorporate at least a part of the optical resonator.

8. The photothermal microscopy system of claim 7, wherein the photodetector is a balanced photodetector and the dither circuit is configured to produce a dither signal that when multiplied by an output of the balanced photodetector, produces an error signal that is proportional to a wavelength detuning between the probe laser light and a resonance of the optical resonator.

9. The photothermal microscopy system of claim 7, comprising a lock-in-amplifier (LIA) coupled to the PID controller, and a signal generator configured to generate a signal at the amplitude modulation frequency and coupled to LIA and to the pump laser.

10. The photothermal microscopy system of claim 1, comprising an optical scanner system operable to change a direction of the modulated pump laser light to allow illumination of different areas of the optical resonator by the modulated pump laser light.

11. The photothermal microscopy system of claim 10, comprising one or more objective lenses, wherein the optical scanner system includes a galvo mirror configured to produce a scanning modulated pump laser light that is delivered to the top section of the optical resonator through the one or more objective lenses.

12. The photothermal microscopy system of claim 1, wherein the particle of interest comprises (a) one or more quantum dots, or (b) a nanosphere.

13. The photothermal microscopy system of claim 1, wherein the particle of interest has a diameter in a range of 5 nm to 100 nm.

14. The photothermal microscopy system of claim 1, wherein the optical resonator has a Q-factor with an order of magnitude of 10⁶.

15. The photothermal microscopy system of claim 1, configured to produce a photothermal signal-to-noise ratio with an order of magnitude of 10⁴.

16. A detector system for use in a photothermal microscopy system, the detector system comprising:
a microtoroid optical resonator configured to operate in a whispering gallery mode (WGM) and configured to accommodate a particle of interest, the microtoroid optical resonator including a pillar below a top section of the microtoroid optical resonator, the pillar formed from a different material than the top section of the microtoroid optical resonator, wherein:
at least a portion of the microtoroid optical resonator is positioned to receive a modulated pump laser light with a first wavelength and an amplitude modulation frequency that is less than 1000 Hz, and
the microtoroid optical resonator is configured to receive a probe laser light with a second wavelength, the second wavelength being different than the first wavelength,
a photodetector positioned to receive light from the microtoroid optical resonator and produce electrical signals or information corresponding to the light received thereon; and
a proportional-integral-derivative (PID) controller communicatively coupled to the photodetector to receive the electrical signals or the information from the photodetector, wherein an output of the PID controller includes information indicative of shifts in resonance frequency of the microtoroid optical resonator in response to illumination of the microtoroid optical resonator with the amplitude modulated laser light.

17. A method for detecting a particle in a photothermal microscopy system, the method comprising:
Illuminating, with a pump laser light at a first wavelength, at least a portion of a top section of an optical resonator that is operating in a whispering gallery mode (WGM), the top section accommodating the particle,
wherein the pump laser light has an amplitude modulation frequency that is less than 1000 Hz, wherein:
the photothermal microscopy system includes a photodetector positioned to receive light from the optical resonator and a proportional-integral-derivative (PID) controller communicatively coupled to the photodetector to receive electrical signals or the information from the photodetector, the PID controller further communicatively coupled to a probe laser to at least partially control an operation of the probe laser, the probe laser providing probe laser light with a second wavelength that is coupled into the optical resonator, the second wavelength being different than the first wavelength; and
using an output of the PID controller to detect shifts in resonance frequency of the optical resonator indicative of a presence of the particle.

18. The method of claim 17, comprising scanning different areas of the top section of the optical resonator using the modulated pump laser light.

19. The method of claim 17, wherein the particle is positioned at a peripheral location on a top surface of the optical resonator.

20. The method of claim 17, wherein the first wavelength is within a range of absorption wavelengths of the particle of interest, and the second wavelength is outside the range of absorption wavelengths.

21. The method of claim 17, comprising detecting a photothermal response associated with the optical resonator using a control-loop signal in response to illumination of the optical resonator.
